(19) United States
(12) Patent Application Publication
(10) Pub. No.: US 2008/0184750 A1
(43) Pub. Date: Aug. 7, 2008

(54) MOTORCYCLE SADDLE LOCKING DEVICE

(76) Inventor: Craig J. Graulich, Oakton, VA (US)

Correspondence Address: IPX CORPORATION, PO BOX 24103, SEATTLE, WA, 98124-0103, US

(21) Appl. No.: 10/605,207

(22) Filed: Aug. 29, 2005

(51) Int. Cl. B62H 5/00

(52) U.S. Cl. 70/233

(57) ABSTRACT

A motorcycle saddle locking device for use in combination with a motorcycle chassis having a rear fender mount and a motorcycle saddle having a rear attachment member for locking the saddle to the rear fender mount, which is comprised of a lock housing; and a locking means which is secured to the locking housing wherein the locking means and locking housing (hereinafter, “the locking device”) bias the rear attachment member between a closed and an opened relationship with respect to the fender mount thereby rendering the saddle between an open and a closed position

### BACKGROUND OF THE INVENTION

The present invention relates to a motorcycle saddle locking device, and in particular, to a locking device for securing a rear seat attachment member of a saddle to a fender mount of a motorcycle rear fender.

### SUMMARY OF THE INVENTION

The present invention relates to a motorcycle saddle locking device, and in particular, to a locking device for securing a rear seat attachment member of a saddle to a fender mount of a motorcycle rear fender.

The motorcycle saddle locking device is designed to securely lock a motorcycle saddle in place. The locking device is designed to be used with any rear fender mount seat design as found on most Harley Davidson Motorcycles (ie. Harley Davidson 1999 Fat Boy, 2002 Road King.)

In one aspect of the present invention, a motorcycle saddle locking device is disclosed. The locking device is designed to be used in combination with a motorcycle chassis having a rear fender mount and a motorcycle saddle having a rear attachment member for locking the saddle to the rear fender mount. Broadly speaking, the locking device is comprised of the following:

a lock housing; and

a locking means which is secured to the locking housing

wherein the locking means and locking housing (hereinafter, “the locking device”) bias the rear seat attachment member between a closed and an opened relationship with respect to the fender mount thereby rendering the saddle between an open and a closed position.

### BRIEF DESCRIPTION OF THE DRAWINGS

FIG. 1 shows a top-view of a standard saddle fender mount 2 for a motorcycle rear fender (not shown) to be used in accordance with the motorcycle saddle locking device of the present invention.

FIG. 2 shows a side-view of the barrel lock assembly 10 (with barrel lock collar 20 removed), in accordance with a preferred embodiment of the present invention;

FIG. 3a shows a top-view of a first embodiment of the barrel lock collar 20, in which the collar is comprised of a first locking tab 39 designed to accommodate an oblong opening 30 on a first rear attachment member 35;

FIG. 3b shows a bottom-view of the first embodiment of the barrel lock collar 20 of FIG. 3a;

FIG. 3c shows a top-view of a second embodiment of the barrel lock collar, in which the collar 20 is comprised of a second locking tab 29 designed to accommodate a round opening 40 on a second rear attachment member 45;

FIG. 3d shows a bottom-view of the second embodiment of the barrel lock collar 20 of FIG. 3c;

FIG. 4 shows the a barrel lock assembly 10 and the collar 20 (with locking tab 29) in combination, in accordance with the preferred embodiment of the present invention;

FIG. 5a shows a first embodiment of the rear attachment member 35 having an oblong hole 30 for use in combination with the collar of FIGS. 3c/3d.

FIG. 5b shows a second embodiment of the rear seat attachment member 45 having a round hole 40 for use in combination with the collar of FIGS. 3a/3b.

FIG. 6a shows a side-view of the second locking tab 39 biased into the forward position with respect to the oblong hole 30 of the first rear seat attachment member 35 when the locking device is disengaged into the open position.

FIG. 6b shows a side-view of the second locking tab 39 biased into the rearward position with respect to the oblong hole 30 of the first rear seat attachment member 35 when the locking device is disengaged into the open position.

FIG. 6c shows a side-view of the first locking tab 29 biased into the rear position with respects to the round hole 40 of the second rear seat attachment member 45 when the locking device is disengaged into the open position;

FIG. 7a shows a side-view of the second locking tab 39 biased into the forward position with respect to the oblong hole 30 of the first rear seat attachment member 35 when the locking device is engaged into the closed position.

FIG. 7b shows a side-view of the second locking tab 39 biased into the rear position with respect to the oblong hole 30 of the first rear seat attachment member 35 when the locking device is engaged into the closed position

FIG. 7c shows a side-view of the first locking tab 29 biased into the rear position with respect to the round hole 40 of the rear seat attachment member 45 when the locking device is engaged into the closed position;

### DETAILED EMBODIMENT

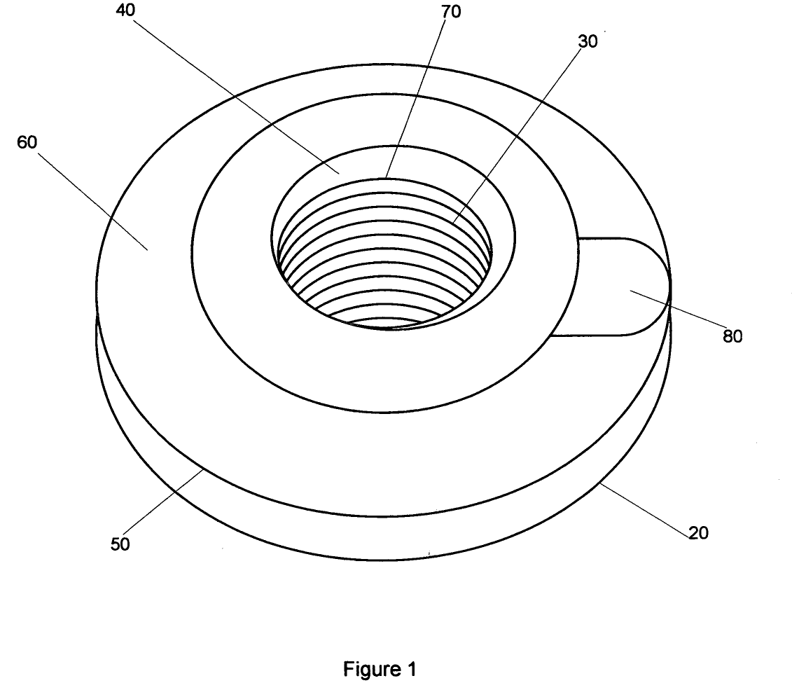

Referring to FIG. 1, a standard rear fender mount 2 is shown. The fender mount 2 is comprised of an opening 3 in the fender 1 of the motorcycle (not shown). The opening 3 has an inner surface 4 and an outer surface 5. The fender mount 2 is secured to the fender (not shown) by a locking key 8.

The outer surface 5 is comprised of a fender mount contact surface 6 for abutting a rear attachment member contact surface when a locking device (with a collar) is brought into a closed relationship with respect to the fender mount 2.

The inner surface 4 is comprised of a female threaded portion 7 for receiving the male threaded portion 13 of the barrel bolt of the barrel lock assembly 10, which will be described herein.

### Best Mode of Performing the Invention

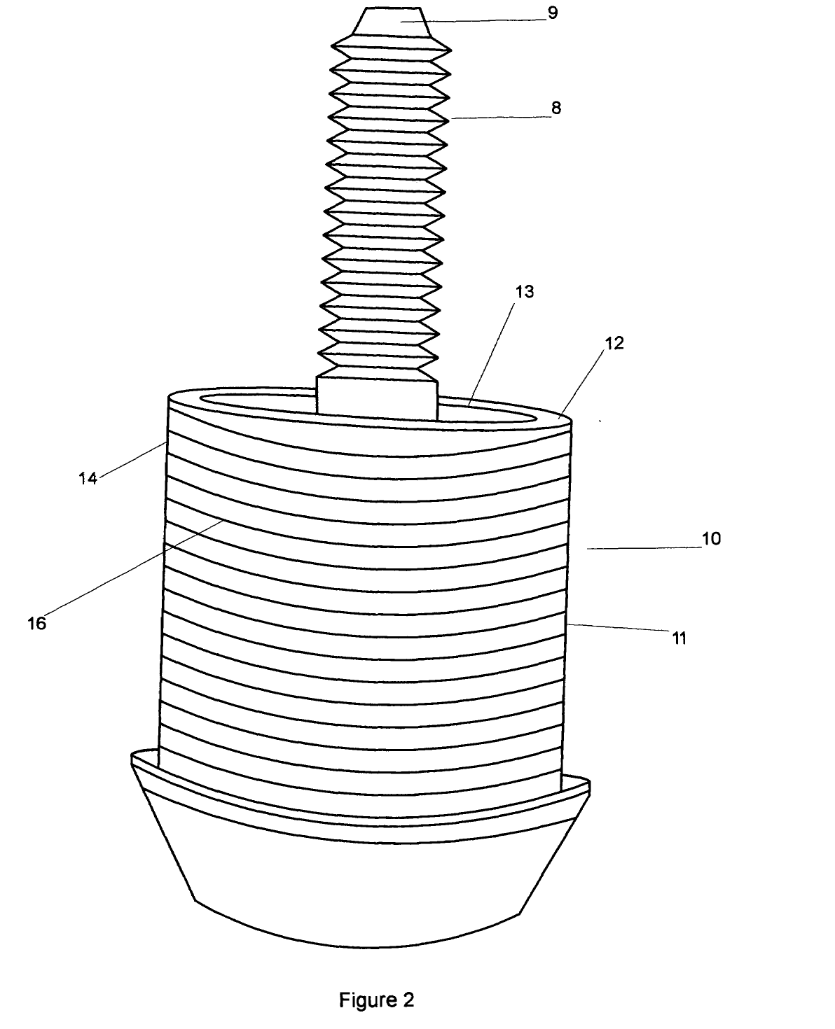

Referring to FIG. 2, a barrel lock assembly 10 is shown, in accordance with the present invention. The barrel lock assembly 10 is shown with the barrel lock collar 20 removed.

Part number #MS-108 (distributed by Leech Industries Inc) discloses a preferred embodiment of a suitable barrel lock assembly 10, in accordance with the locking device of the present invention.

The barrel lock assembly 10 is comprised of a barrel body 11 and a barrel bolt 9. The barrel bolt 12 is comprised of a male threaded portion 13 which is used to secure the barrel body 11 into the female threaded portion 9 of the fender mount 2.

The barrel housing 11 is comprised of an outer barrel housing 14 and an inner housing 15. The inner barrel housing 15 carries the internal locking mechanism (not shown) of the barrel lock assembly 10. The scope of the invention, contemplates any internal locking mechanism for the barrel lock which provides the desired locking relationship between the collar and the fender mount.

The barrel lock assembly 10 is sold commercially by Leech Industries Incorporated under Part Number #MS-108.

The barrel lock assembly 10 uses a locking key 19 to bias the locking assembly 10 between “an open position” and “a closed position”, each of which will be described herein in more detail.

The term “locking means” may be used in the claims, under a broad construction of the claims, to describe any suitable locking device which functions with the lock housing to bias the rear attachment member between an opened and a closed relationship with respect to the fender mount.

Preferably, the outer barrel housing 14 is comprised of a male-threaded portion 13 which is threadably engageable with a female-threaded portion 23 of a barrel lock collar 20, which will be described herein.

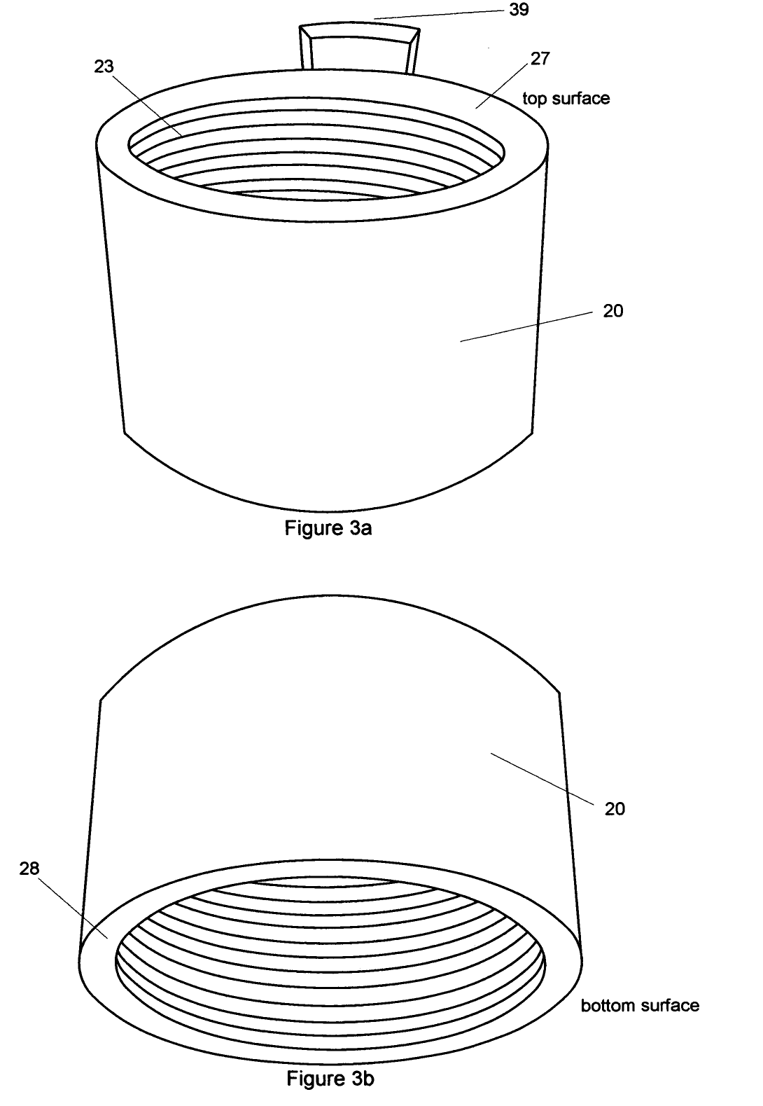

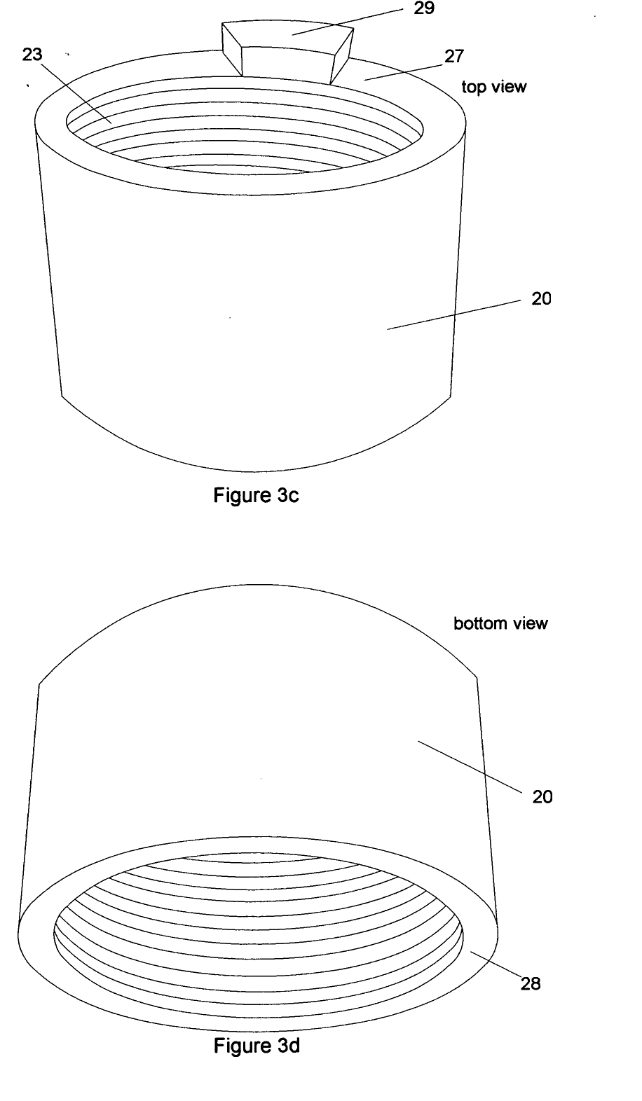

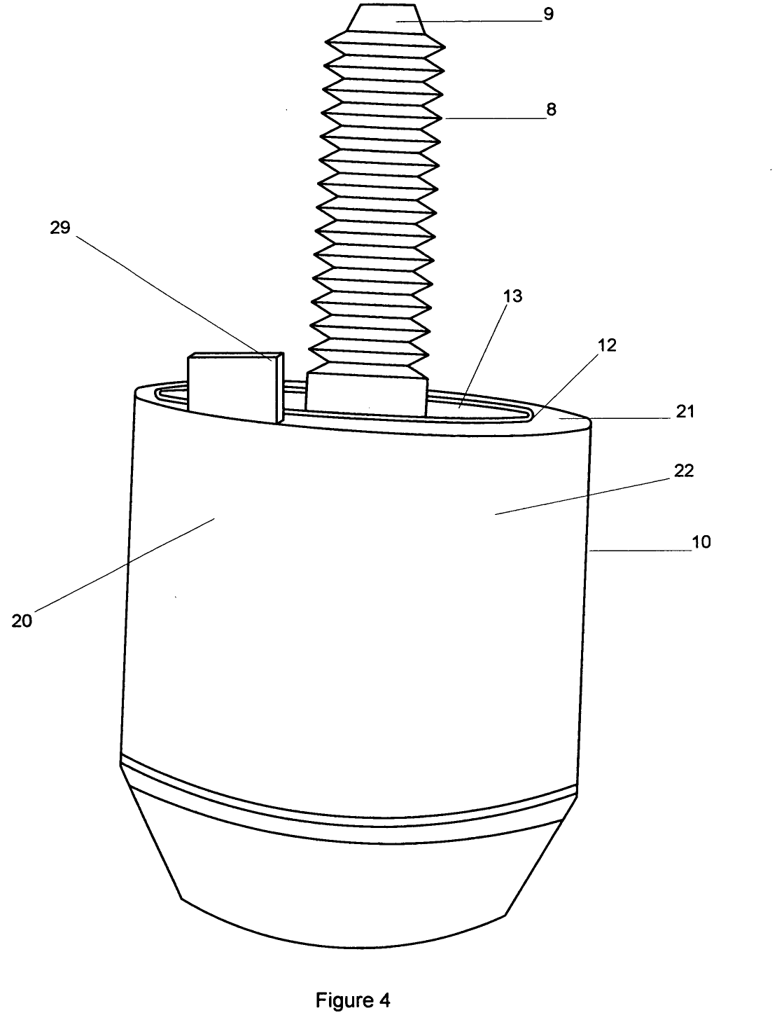

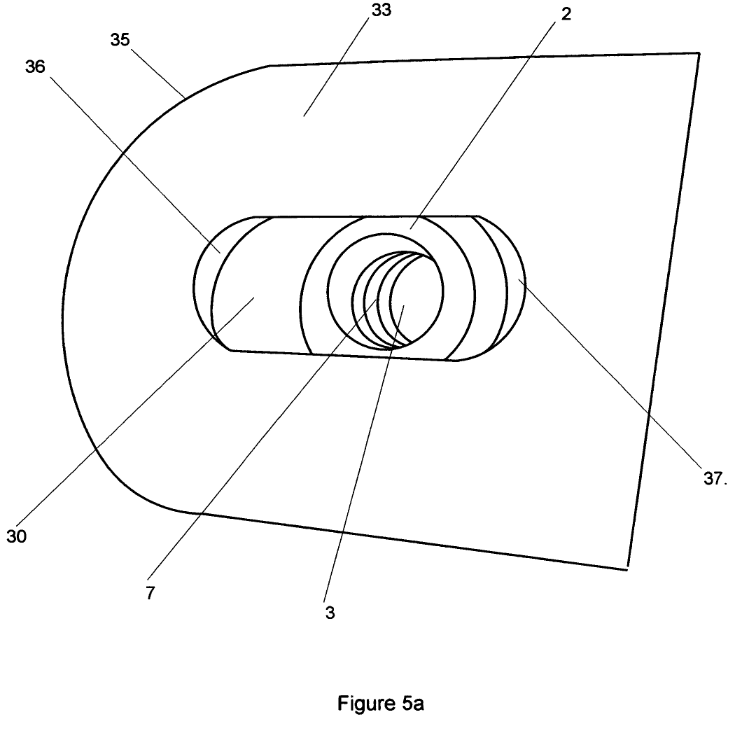

Referring to FIG. 3a-d, a barrel lock collar 20 is shown. The barrel lock collar 20 is comprised of an inner collar housing 21 and an outer collar housing 22.

The inner collar portion 21 is comprised of a female-threaded portion 23 which is threadably engageable with the male threaded portion 16 of the outer barrel housing 14.

The outer collar portion 22 serves as a protective housing to protect the internal locking mechanism of the barrel lock assembly 10 from tampering or damage.

The inner collar portion 21 carries the collar contact surface 27 which abuts a rear attachment contact surface 33 on the rear attachment member 35 when the locking device is biased into the closed position.

In a first embodiment, the collar 20 is further comprised of a first locking tab 29 (see FIG. 3a). The first locking tab 29 is designed to accommodate an oblong opening 30 on a first rear seat attachment member 35, which will be described herein.

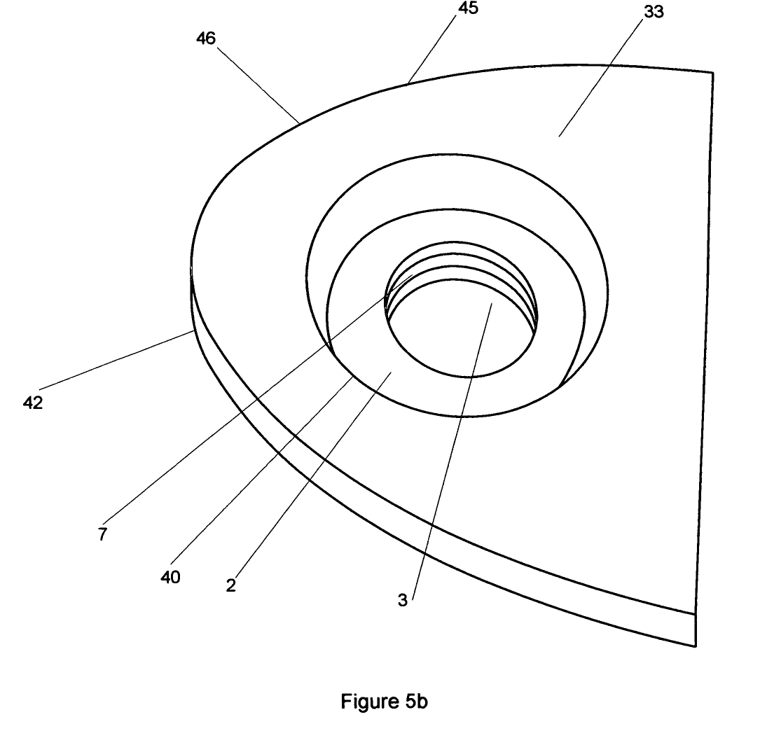

As shown in FIG. 5a, a first embodiment of a rear seat attachment member 35 is shown. The first embodiment of the rear seat attachment member 35 (hereinafter, “first attachment member”) is found on most “after market” saddles. The first attachment member 35 is comprised of a first body portion 34 having an oblong hole 40. The first body portion 34 supports both a first locking slot 36 and a second locking slot 37 for abutting a first locking tab 29 carried by the collar 20.

As shown in FIG. 5b, a second embodiment of a rear seat attachment member 45 is shown. The second embodiment of the rear seat attachment member 45 (hereinafter, “second attachment member”) is found on most Harley Davidson OEM saddles. The second attachment member 45 is comprised of a second body portion 43 having a round opening 40. The second body portion 44 supports a third locking slot 46 for abutting a first locking tab 39 carried by the collar 20.

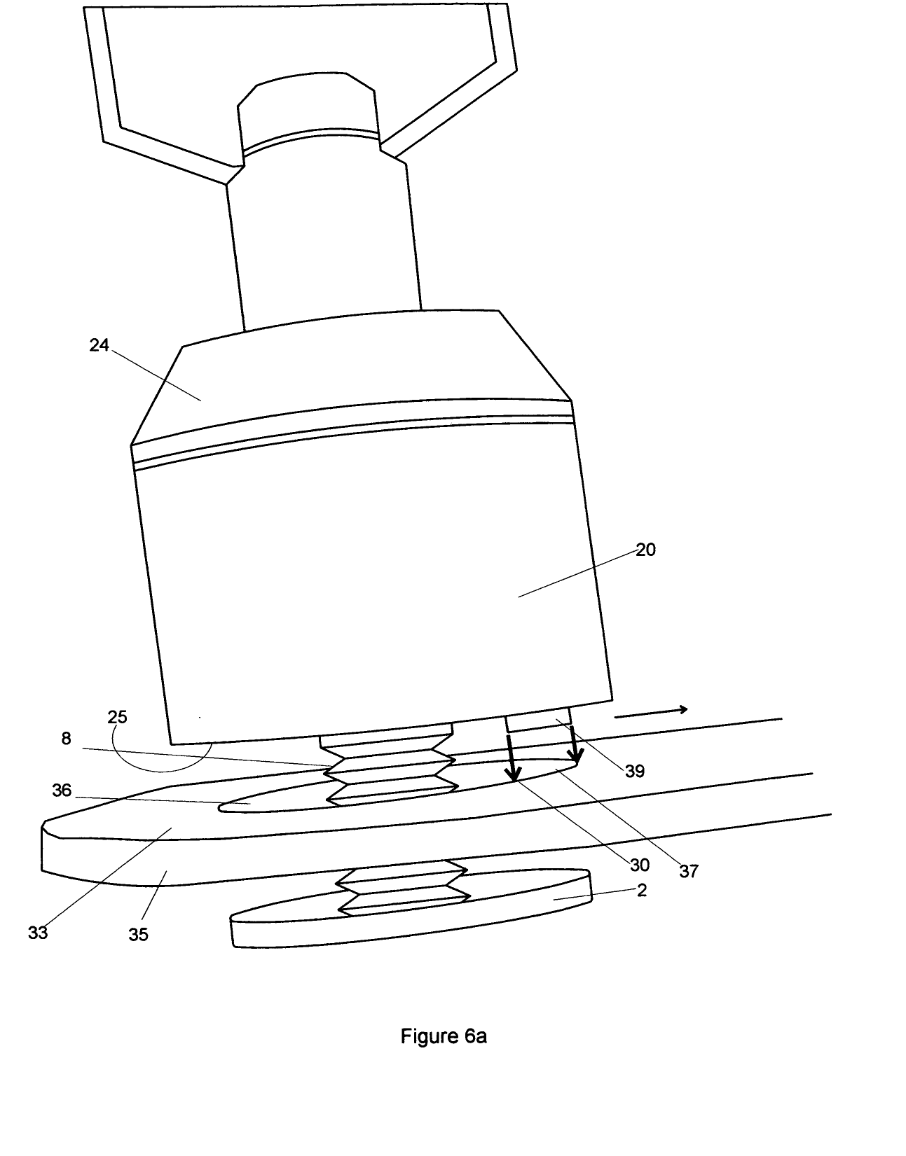

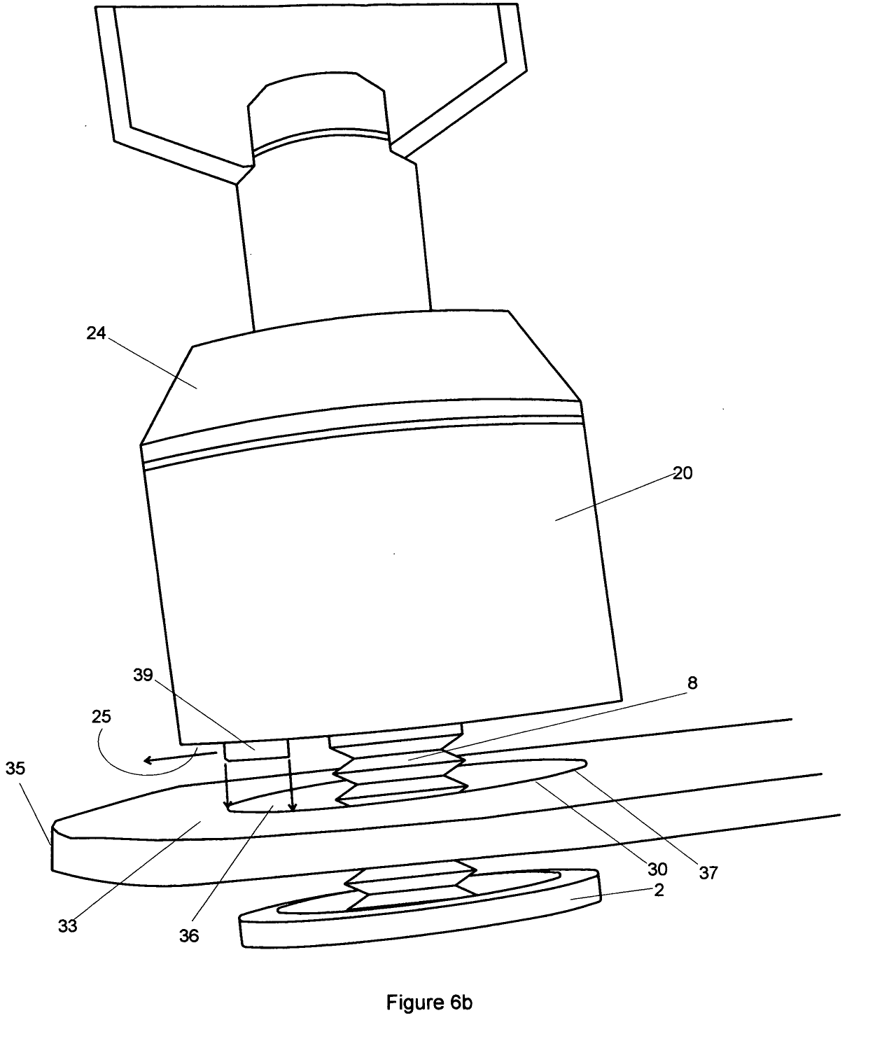

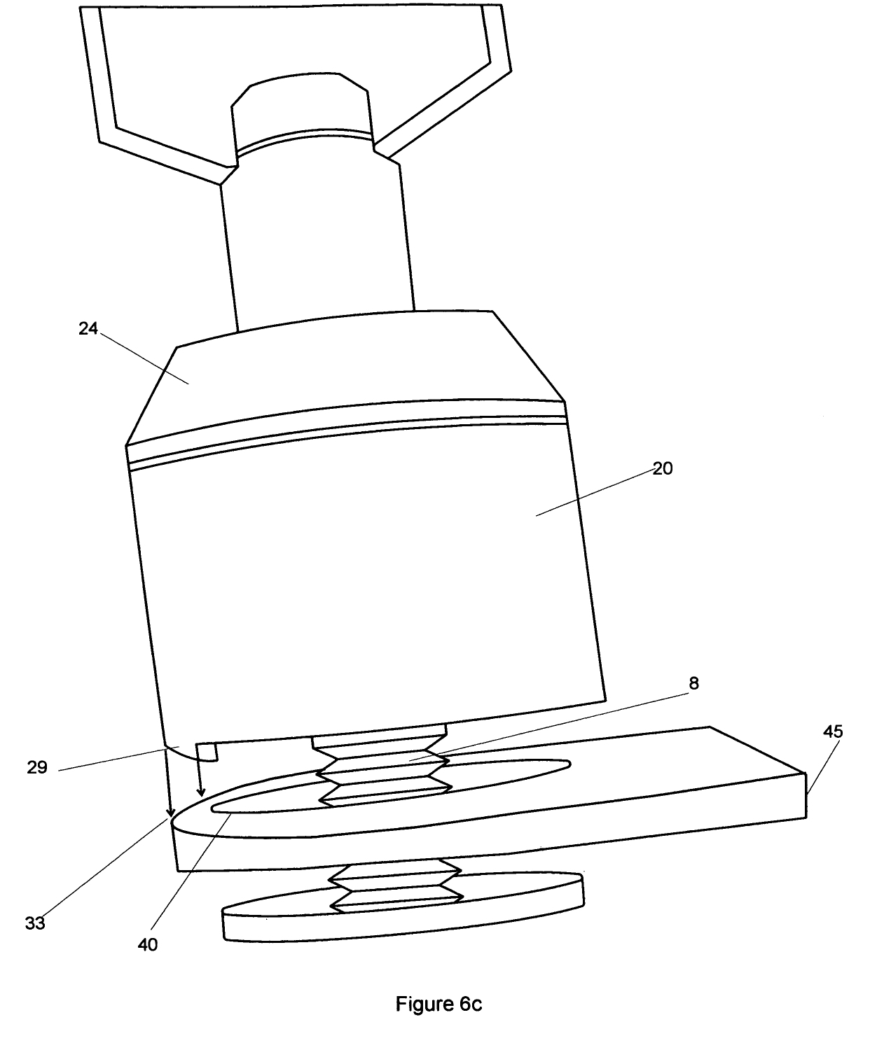

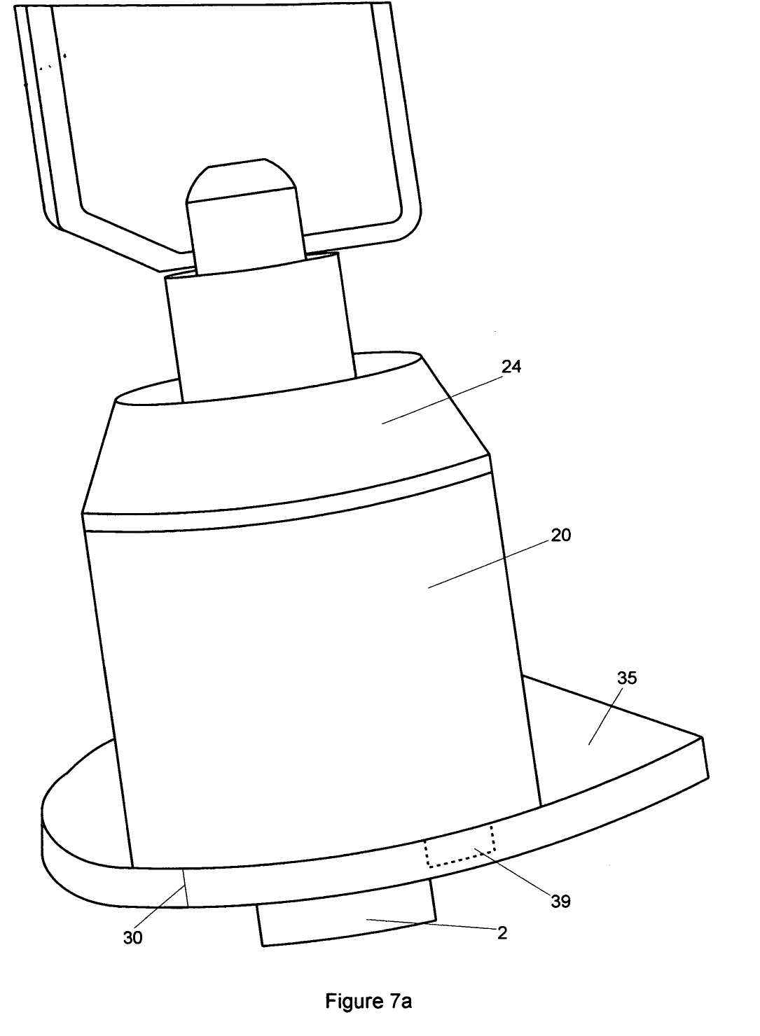

Referring to FIG. 6a, the first locking tab 29 may be positioned in the forward position (towards the front of the motorcycle) to keep the saddle forward on the motorcycle. The first locking slot 36 of rear attachment member 35 meets the first locking tab 29 to bias the rear seat attachment member 35 into the forward position. This allows the saddle to be adjusted into a forward position relative to the chassis of the motorcycle.

Referring to FIG. 6b, the first locking tab 29 may also be positioned in the back position (towards the rear of the motorcycle) to allow the saddle to sit back on the motorcycle. The second locking slot 37 of rear attachment member 35 receives the first locking tab 29 of the collar 20 to bias the rear seat attachment member 35 into a back position. This allows the saddle to be adjusted into a rearward position relative to the chassis of the motorcycle.

In a second embodiment, the collar 20 is comprised of a second locking tab 39 (see FIG. 6c). The second locking tab 39 is designed to accommodate a round opening 40 on the second rear attachment member 45.

Preferably, as shown in FIG. 6b, the second locking tab 39 is designed to be positioned on a third locking slot 46 on the outside leading edge of the second rear seat attachment 45. The second locking tab 39 is designed to fit with most Harley Davidson OEM seats.)

The term “lock housing” may be used in the claims, under a broad construction of the term, to describe an integral one-piece collar 20 and barrel housing 11. Alternatively, the term “lock housing” may be used in the claims, under a narrow construction of the term, to describe the combination of the collar 20 and barrel body 11 components.

As mentioned in the claims, the preferred method of combining the collar and barrel housing is by using a threaded relationship between the male threaded portion 16 of the outer barrel housing 14 and the female threaded portion 23 of the inner collar housing 20.

### Assembly of the Motorcycle Locking Device

As mentioned previously, the collar 20 and barrel lock assembly 10 are combined to form a one-piece barrel lock (hereinafter, “the locking device”). A thread locking compound may be added to the male threaded portion 13 of the barrel bolt 12 to secure the collar 20 to the barrel lock assembly 10.

As mentioned previously, the first embodiment of the collar 20 comprising the first locking tab 29 (see FIG. 3a) is designed to be used with an oblong opening 30 on the first rear seat attachment member 35. Accordingly, the male threaded portion 13 of the barrel bolt 12 passes through the oblong opening 30 of the rear attachment member 35, and is screwed securely into the female threaded portion 9 of the fender mount 2 thereby securing the locking device to the fender.

Similarly, the second embodiment of the collar 20 comprising the second locking tab 39 (see FIG. 3a) is designed to be used with the round opening 40 of the second rear seat attachment member 45. Accordingly, the male threaded portion 13 of the barrel bolt 12 passes through the round opening 40 of the rear attachment member 45, and is screwed securely into the female threaded portion 9 of the fender mount 2 thereby securing the locking device to the fender.

### Using the Locking Device

The term “closed position” is used to describe the relationship of the collar and the opening on the rear attachment member when the leading edge of the locking tab is engaged into an abutting relationship with respect to the locking slot on the opening of the rear attachment member.

The term “abutting” is used in the disclosure to mean that the leading edge is situated contiguous, so as to make contact with the locking slot on the opening of the rear attachment member.

Alternatively, the term “open position” is used to describe the relationship of the collar and rear attachment member when the leading edge of the locking tab is disengaged from an abutting relationship with respect to the locking slot of the opening on the rear attachment member.

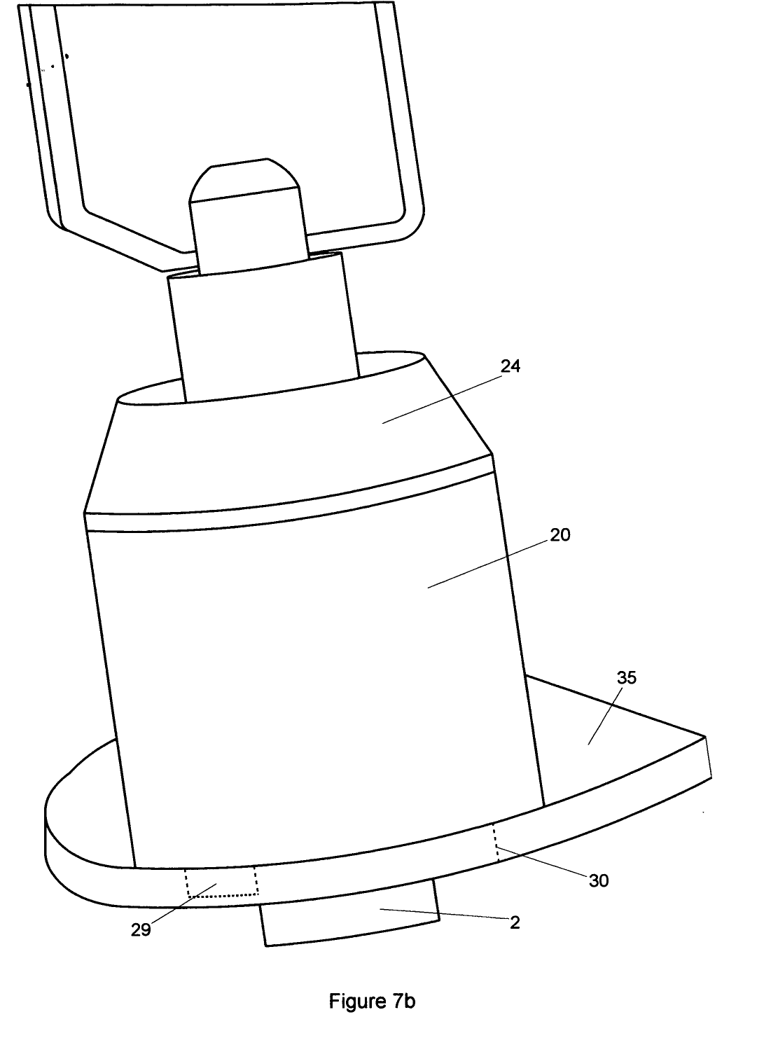

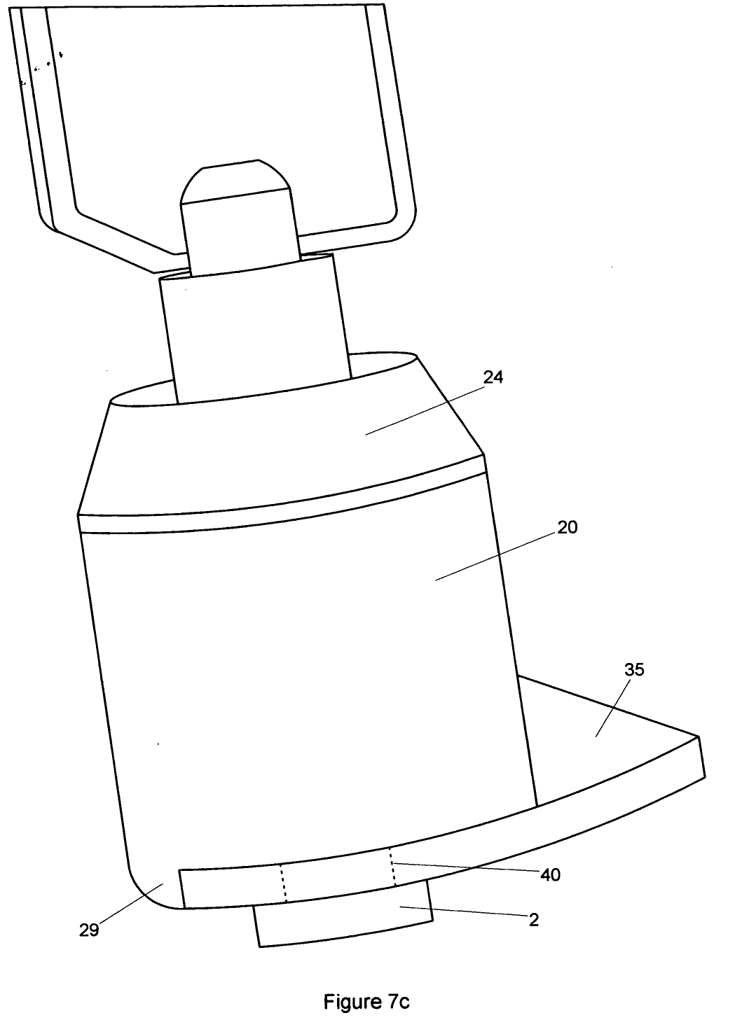

Accordingly, in a closed position, the first locking tab 29 is biased into a closed relationship with the first locking slot 36 or second locking slot 37 on the oblong opening 30 of the rear attachment member 35 (see FIGS. 7a/7b).

Similarly, in an open position, the first locking tab 29 is biased into an open relationship with the first locking slot 36 or second locking slot 37 on the oblong opening 30 of the first rear attachment member 35 (see FIG. 6a/6b).

Accordingly, in a closed position, the second locking tab 39 is biased into a closed relationship with the third locking slot 46 of the round opening 40 of the second rear attachment member 45 (see FIG. 7c).

Similarly, in an open position, the second locking tab 39 is biased into an open relationship with respect to the third locking slot 46 on the round opening 40 of the second rear attachment member 45 (see FIG. 6c).

As mentioned previously, the preferred embodiments of the locking device use a barrel lock assembly 10. The locking device of the barrel lock is biased between “the open position” and “the closed position” by turning the locking key 8 of the locking device. The locking key 8 is turned in a clockwise direction to lock the barrel lock thereby engaging the locking device in the closed position. Conversely, the locking key 8 is turned in a counter clockwise to open the barrel lock thereby disengaging the locking device in the open position.

By locking the locking device the locking tab is biased into the closed position and by opening the locking device the locking tab is biased into the open position. Once the locking device has been opened, it may be removed from the fender mount by unscrewing the barrel bolt from the fender mount.

### Parts List:

fender (not shown);
fender mount 2;
opening 3;
inner surface 4;
outer surface 5
fender mount contact surface 6;
female threaded portion 7;
locking key 8
barrel lock assembly 10;
barrel lock housing 11;
barrel bolt 12;
male threaded portion 13 of barrel bolt 12;
outer barrel housing 14;
inner barrel housing 15
male threaded portion 16 of outer barrel housing 14;
internal locking mechanism (not shown)
locking key 19;
barrel collar 20
inner collar housing 21;
outer collar housing 22;
female-threaded portion 23 of inner collar housing 21
housing 24
second contact surface 25
first locking tab 29
second locking tab 39
(collar 20+barrel lock assembly 10=locking device)
(barrel lock assembly 10=internal locking mechanism (not shown)+barrel lock housing+barrel bolt 12)
first rear attachment member 35
first rear attachment contact surface 33
first body portion 34
first locking slot 36
second locking slot 37
oblong opening 30
second rear attachment member 45
second rear attachment contact surface 43
second body portion 44
third locking slot 46
round opening 40

I claim:

1. A motorcycle saddle locking device for use in combination with a motorcycle chassis having a rear fender mount and a motorcycle saddle having a rear attachment member for locking the saddle to the rear fender mount, which is comprised of:
a lock housing; and
a locking means which is secured to the locking housing wherein the locking means and locking housing (hereinafter, “the locking device”) bias the rear attachment member between a closed and an opened relationship with respect to the fender mount thereby rendering the saddle between an open and a closed position.

2. The lock housing, as claimed in claim 1, wherein the lock housing is comprised of an inner locking surface.

3. The locking means, as claimed in claim 2, wherein the inner locking surface is comprised of a male threaded portion.

4. The locking means, as claimed in claim 3, wherein the locking means is comprised of an outer locking surface.

5. The locking means, as claimed in claim 4, wherein the outer locking surface is comprised of a female threaded portion.

6. The motorcycle saddle locking device, wherein the male threaded portion of the locking housing is combined with the female threaded portion of the locking means by threading the male threaded portion of the locking housing into the female threaded portion of the locking means.

7. The motorcycle saddle locking device, as claimed in claims 2 or 6, wherein the locking means is a barrel lock.

8. The motorcycle saddle locking device, as claimed in claim 8, wherein the lock housing is further comprised of a locking tab.

9. The motorcycle saddle locking device, as claimed in claim 9, wherein the locking tab engages an outside surface on the rear attachment member.

10. The motorcycle saddle locking device, as claimed in claim 9, wherein the locking tab engages an inside surface on the rear attachment member.
